(19) United States
(12) Patent Application Publication
(10) Pub. No.: US 2022/0101641 A1
(43) Pub. Date: Mar. 31, 2022

(54) APPARATUS AND METHOD FOR DETECTING POSITION OF AN ELECTRONIC SHELF LABEL

(71) Applicant: Hanshow Technology Co., Ltd., Jiaxing, Zhejiang (CN)

(72) Inventors: Shiguo HOU, Jiaxing, Zhejiang (CN); Xunyuan SU, Jiaxing, Zhejiang (CN); Min LIANG, Jiaxing, Zhejiang (CN); Yaping JI, Jiaxing, Zhejiang (CN); Yitang ZHUANG, Jiaxing, Zhejiang (CN)

(21) Appl. No.: 17/618,395

(22) PCT Filed: Jun. 12, 2019
(86) PCT No.: PCT/CN2019/090852

§ 371 Date: Dec. 10, 2021

(51) Int. Cl. G06V 20/70; G06K 9/62

(52) U.S. Cl. CPC G06V 20/70; G06K 9/6269

(57) ABSTRACT

The present disclosure provides a device and method for position detection of electronic shelf labels. The device comprises: a lighting control module configured to send a lighting signal to electronic shelf labels; electronic shelf labels configured to receive the lighting signal and light up according to their respective preset lighting rules; a camera configured to take photos of the electronic shelf labels being lighting up according to a preset photographing rule to obtain image data of the electronic shelf labels; a detection module configured to determine positions of the electronic shelf labels on a shelf based on the image data of the electric shelf labels. The present disclosure can automatically detect positions of the electronic shelf labels on the shelf with high efficiency.

### TECHNICAL FIELD

The present disclosure relates to a technical field of display detection, and in particular to an apparatus and method for detecting position of an electronic shelf label.

### BACKGROUND

Display means to exhibit products at a prominent position to attract attention of consumers and enhance their desire to buy. An Electronic label is set on a shelf in supermarkets corresponding to a product, and the position of the shelf label on the shelf needs to be detected. The traditional detection method is manual detection with low efficiency. Therefore, an effective method for automatically detecting the position of the electronic shelf label is needed.

### SUMMARY

An embodiment of the present disclosure provides an apparatus for detecting position of an electronic shelf label, which can automatically detect position of an electronic shelf label with high efficiency, the apparatus comprises:

a lighting control module configured to send a lighting signal to the electronic shelf label;

the electronic shelf label, which is configured to light up according to a preset lighting rule upon receipt of the lighting signal;

a camera configured to capture a picture of the electronic shelf label according to a preset capturing rule to obtain image data of the electronic shelf label, after the electronic shelf label lights up;

a detection module configured to determine position of the electronic shelf label on a shelf based on the image data of the electric shelf label.

An embodiment of the present disclosure further provides a method for detecting position of an electronic shelf label, which can automatically detect position of an electronic shelf label with high efficiency, the method comprises:

receiving image data of the electronic shelf label which is obtained by a camera by capturing a picture of the electronic shelf label according to a preset capturing rule after the electronic shelf label lights up, wherein the electronic shelf label lights up according to a preset lighting rule upon receipt of a lighting signal;

determining position of the electronic shelf label on a shelf based on the image data of the electric shelf label.

An embodiment of the present disclosure further provides a computer device comprising a memory, a processor and a computer program stored in the memory and executable on the processor, wherein the processor executes the computer program to implement the method as described above.

An embodiment of the present disclosure further provides a computer-readable storage medium storing a computer program for implementing the method as described above.

In the embodiment of the present disclosure, the lighting control module sends a lighting signal to the electronic shelf label, the electronic shelf label lights up according to a preset lighting rule upon receipt of the lighting signal, the camera captures a picture of the electronic shelf label according to a preset capturing rule to obtain image data of the electronic shelf label after the electronic shelf label lights up, and the detection module determines position of the electronic shelf label on a shelf based on the image data of the electric shelf label. The process of lighting the electronic shelf label, capturing a picture to obtain the image data of the electronic shelf label, and obtaining the position of the electric shelf label on the shelf are all completed automatically without manual participation, thereby improving the efficiency of detecting position of the electronic shelf label.

### BRIEF DESCRIPTION OF DRAWINGS

The following drawings are used for a clear understanding of the present disclosure and constitute a part of the present disclosure, and shall not be construed as any limitation to the present disclosure. In the drawings:

FIG. 1 is a schematic diagram of an apparatus for detecting position of an electronic shelf label in an embodiment of the present disclosure;

FIG. 2 is a schematic diagram of positions of components of an apparatus for detecting position of an electronic shelf label in an embodiment of the present disclosure;

FIG. 3 shows specific steps of a method for detecting position of an electronic shelf label in an embodiment of the present disclosure;

FIG. 4 is a flowchart of a method for detecting position of an electronic shelf label in an embodiment of the present disclosure.

### DESCRIPTION OF EMBODIMENTS

For a clearer understanding of the objects, technical features and effects of this disclosure, specific embodiments will now be described with reference to the drawings. The described embodiments are intended only to schematically illustrate and explain this disclosure and do not limit the scope of this disclosure.

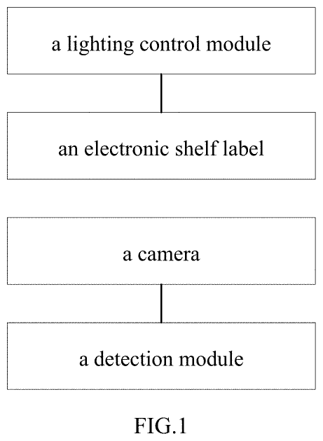

FIG. 1 is a schematic diagram of an apparatus for detecting position of an electronic shelf label in an embodiment of the present disclosure. As shown in FIG. 1, the apparatus comprises:

a lighting control module configured to send a lighting signal to the electronic shelf label;

the electronic shelf label, which is configured to light up according to a preset lighting rule upon receipt of the lighting signal;

a camera configured to capture a picture of the electronic shelf label according to a preset capturing rule to obtain image data of the electronic shelf label, after the electronic shelf label lights up;

a detection module configured to determine position of the electronic shelf label on a shelf based on the image data of the electric shelf label.

In the embodiment of the present disclosure, the lighting control module sends a lighting signal to the electronic shelf label, the electronic shelf label lights up according to a preset lighting rule upon receipt of the lighting signal, the camera captures a picture of the electronic shelf label according to a preset capturing rule to obtain image data of the electronic shelf label after the electronic shelf label lights up, and the detection module determines position of the electronic shelf label on a shelf based on the image data of the electric shelf label. The process of lighting the electronic shelf label, capturing a picture to obtain the image data of the electronic shelf label, and obtaining the position of the electric shelf label on the shelf are all completed automatically without manual participation, thereby improving the efficiency of detecting position of the electronic shelf label.

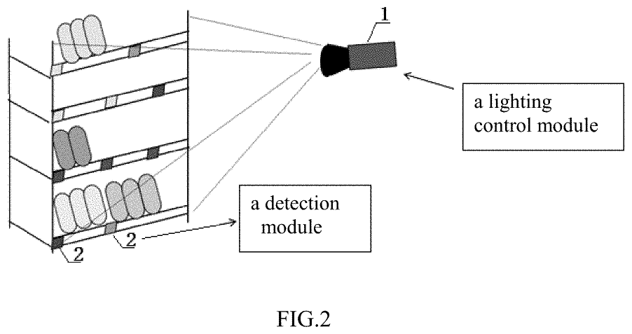

FIG. 2 is a schematic diagram of positions of components of the apparatus for detecting position of an electronic shelf label in an embodiment of the present disclosure. As shown in FIG. 2, the camera 1 is installed on an opposite side of a display shelf on which a plurality of products are displayed, and the electronic shelf labels 2 are located on the left side under the corresponding products. The lighting control module may be a computer or other control devices that can communicate wirelessly or by wire with the electronic shelf labels. The detection module may be a computer or other computing devices that can communicate wirelessly or by wire with the camera. The lighting control module and the detection module may also be installed on a computer, such as a portable computer.

The electronic shelf label has a serious lighting latency, and the lighting control module cannot know whether the shelf label have received the lighting signal, and there is a chance that the electronic shelf label may not receive the lighting signal, so simple lighting detection has a serious time synchronization problem and it is difficult to know whether light number of the electronic shelf label has been switched. Therefore it is necessary to re-light the unlighted electronic shelf label in a capturing time.

In an embodiment, the lighting control module is further configured to send, if there is an unlighted electronic shelf label, the lighting signal to the unlighted electronic shelf label in a preset detection time.

In the above embodiment, the preset detection time is related to a preset total capturing time and should be shorter than the preset total capturing time. For example, after the electronic shelf label lights up, the preset total capturing time for capturing pictures of the electronic shelf label according to the preset capturing rule is 40 minutes, and the preset detection time may be 20 minutes because the ideal lighting delay time for the supermarket may be up to 20 minutes or even longer. Twenty minutes after the electronic shelf label on the shelf of the supermarket receives the lighting signal, the electronic shelf label that have not yet been detected can be known. For the unlighted electronic shelf label, the lighting control module sends the lighting signal again, and the camera continues to capture a picture according to the preset capturing rule until the summed-up capturing time reaches the preset total capturing time, so that all electronic shelf labels can be detected, thereby improving the detection success rate.

There may be many kinds of preset lighting rules for the electronic shelf label, through which the position of the electronic shelf label on the shelf can be determined based on the image data of the electronic shelf label obtained by the camera. An embodiment of the preset lighting rule will be given below.

In an embodiment, the lighting signal is a lighting trigger signal.

The electronic shelf label is specifically configured to, upon receipt of the lighting trigger signal, light up cyclically according to a preset lighting color sequence until a summed-up lighting time reaches a preset total lighting time, with the time of each lighting being a preset single lighting time; wherein the preset lighting color sequence comprises a starting lighting color and at least two coded lighting colors different from the starting lighting color, and adjacent coded lighting colors of the preset lighting color sequence are different from each other.

In the above embodiment, the preset lighting color sequence is a group of lighting colors, wherein the starting lighting color is used to distinguish different electronic shelf labels and is the first color element in the preset lighting color sequence and is different from the coded lighting color. For example, if the starting lighting color is white, the coded lighting color can only be a color other than white. There are at least two coded lighting colors, and the adjacent coded lighting colors in the preset lighting color sequence are different from each other. For example, the coded lighting colors include red and green. In the preset lighting color sequence, red cannot be adjacent to red and only to green. The number of color elements in the preset lighting color sequence can be multiple. There may be repeated coded light colors in the preset lighting color sequence, as long as the adjacent coded lighting colors are different from each other. For example, the preset lighting color sequence may be {white, red, green, red, green, red, green, red}. This lighting color sequence includes eight color elements, in which white is the starting lighting color and red and green are the two coded lighting colors. Red and green in this lighting color sequence can be reused, but the adjacent colors are different from each other. For another example, the preset lighting color sequence may be {white, red, green, blue, green, purple, green, red}. This lighting color sequence includes nine color elements. In addition, each electronic shelf label has a unique preset lighting color sequence, and the number of color elements of the preset lighting color sequences of different electronic shelf labels is the same to facilitate processing of the image data.

Upon receipt of the lighting trigger signal, the electronic shelf label lights up cyclically according to the preset lighting color sequence. For example, the preset lighting color sequence of the electronic shelf label is {white, red, green, red, green, red, green, red}. If the preset single lighting time is 1 second and the preset total lighting time is 2 minutes and 20 seconds, the electronic shelf label will keep lighting up for 2 minutes and 20 seconds. The electronic shelf label lights up cyclically according to the colors in the preset lighting color sequence, and lights up for 1 second of each color. After the color of the last color element of the preset lighting color sequence has lighted up, the first color of the preset lighting color sequence lights up again, that is, the starting lighting color (i.e., white). The above-described lighting process is preferably performed in a dark room, so that the lighting color can be more easily distinguished and the image can be made more clear.

In specific implementation, there are many methods for the detection module to determine the position of the electronic shelf label on the shelf according to the image data of the electronic shelf label, and one embodiment will be given below.

In an embodiment, the detection module is specifically configured to:

input the image data of the electronic shelf label into an electronic shelf label identification model to obtain an identifier of the electric shelf label;

determine the position of the electronic shelf label on the shelf based on the identifier of the electric shelf label.

In the above embodiment, the electronic shelf label identification model can be obtained previously, so it is easy to obtain the identifier of the electronic shelf label by inputting the image data of the electronic shelf label into the electronic shelf label identification model, which is a simple method with high efficiency and high accuracy. The detection module stores a corresponding relationship between the identifier of the electronic shelf label and the position of the electronic shelf label on the shelf. Based on the corresponding relationship, the position of the electronic shelf label on the shelf can be detected quickly. Since the identifier of the electronic shelf label correspond to identifier of the product (e.g., SKU), the position of the product on the shelf can also be determined. Of course, the product may also be other items managed by the electronic label.

In specific implementation, the electronic shelf label identification model can be obtained by various methods, and one method will be given below.

In an embodiment, the electronic shelf label identification model is obtained by a training which includes:

obtaining historical image data of the electronic shelf label;

identifying a starting lighting color and coded lighting colors of the electronic shelf label from the historical image data;

training the electronic shelf label identification model with starting lighting color and coded lighting colors of the electronic shelf label;

adjusting parameters of the electronic shelf label identification model in the training, until a loss function of the electronic shelf label identification model meets a preset convergence condition, thereby obtaining a trained electronic shelf label identification model.

In the above described embodiment, the starting lighting color and the coded lighting colors of the electronic shelf label can be identified from the historical image data of the electric shelf label, so the preset lighting color sequence of the electronic shelf label can be obtained based on the starting lighting color and the coded lighting colors of the electric shelf label. Therefore, by training the electronic shelf label identification model with the starting lighting color and the coded lighting colors of the electronic shelf label, the relationship between the preset lighting color sequence and the identifier of the electronic shelf label can be obtained, thereby obtaining the trained electronic shelf label identification model.

In the above process, the identifier of the electronic shelf label can be obtained from the electronic shelf label identification model only based on the lighting color of the electronic shelf label. Since the lighting color is easy to distinguish, the accuracy of the identification of the electronic shelf label can be up to 99.99%.

There may be many kinds of preset capturing rules, and one embodiment will be given below.

In an embodiment, the camera is specifically configured to capture a group of pictures for each preset group-capturing time interval, until a summed-up capturing time reaches a preset total capturing time.

In the above embodiment, the preset total capturing time can be preset, e.g., 40 minutes. The preset capturing time needs to be longer than the preset detection time, so as to ensure that all the electronic shelf labels can be captured under a lighting state. The preset group-capturing time interval may be two minutes. The shorter the preset group-capturing time interval is, the shorter the lighting time of the electronic shelf label is, thereby reducing the energy consumption of the electronic shelf label.

In an embodiment, the camera is specifically configured to capture one picture for each preset single-capturing time interval, until the number of captured pictures reaches a preset per-group number, wherein the preset single-capturing time interval is shorter than the preset single lighting time.

In the above embodiment, the preset per-group number is preferably greater than the number of color elements of the preset lighting color sequence, so as to ensure that each lighting color of the electronic shelf label can be captured. For example, the number of color elements of the preset lighting color sequence is 8, the preset per-group number may be 21. Since the preset single-capturing time interval is shorter than the preset single lighting time, each lighting color of the electronic shelf label can be captured. For example, if the preset single lighting time is 1 second, the preset single-capturing time interval may be 0.8 seconds.

A specific embodiment will be given below to illustrate the specific application of the apparatus for detecting position of the electronic shelf label in an embodiment of the present disclosure.

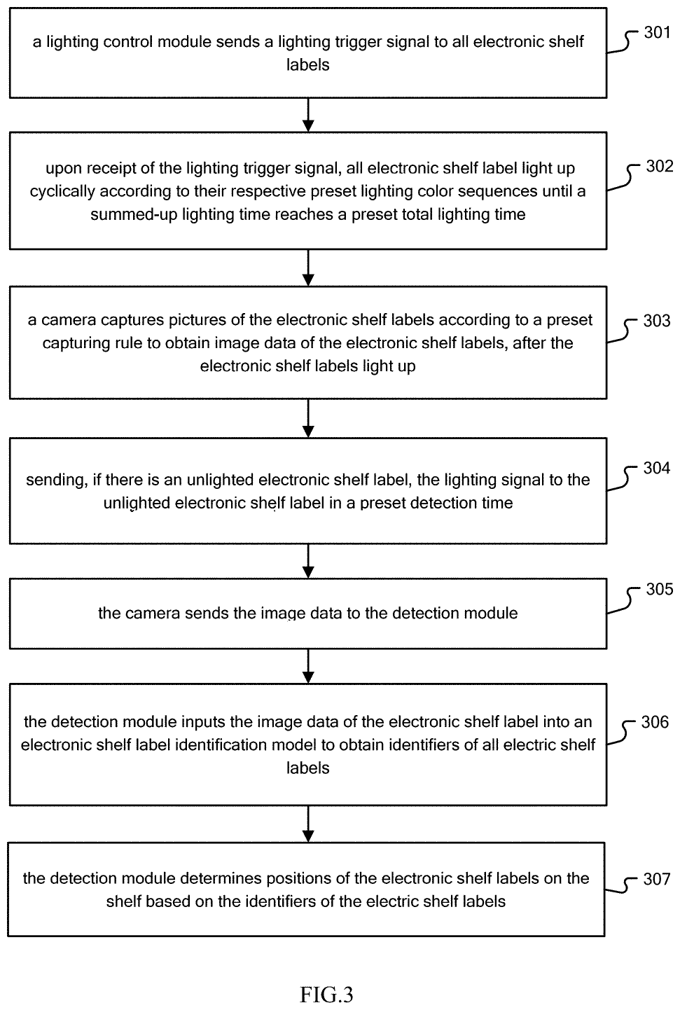

There may be many display shelves in the supermarket, and there may be many cameras on the opposite side of each display shelf. The lighting control module and the detection module are integrated on a portable computer and can communicate wirelessly with the electronic shelf label and the camera. FIG. 3 shows specific steps of detecting the position of the electronic shelf label according to an embodiment of the present disclosure. As shown in FIG. 3, the specific steps of detecting the position of the electronic shelf label may comprise:

a step 301: a lighting control module sends a lighting trigger signal to all electronic shelf labels;

a step 302: upon receipt of the lighting trigger signal, all electronic shelf label light up cyclically according to their respective preset lighting color sequences until a summed-up lighting time reaches a preset total lighting time;

wherein the preset lighting color sequence of each electronic shelf label may include eight color elements, in which the first color element is the starting lighting color (e.g., white). There may be six colors of the coded lighting colors applied in the preset lighting color sequences of all electronic shelf labels, and the adjacent colors of the preset lighting color sequence of each electronic shelf label are different from each other. The preset pre-color lighting time may be 1 second, one lighting cycle may be 8 seconds, and the preset total lighting time may be 2 minutes and 30 seconds;

a step 303: a camera captures pictures of the electronic shelf labels according to a preset capturing rule to obtain image data of the electronic shelf labels, after the electronic shelf labels light up;

wherein the camera may be a POE camera of 2 megapixels, and the camera captures a group of pictures for each 2 minutes until a summed-up capturing time reaches a preset total capturing time which may be 40 minutes, and each group of pictures may include 21 pictures;

wherein when capturing each group of pictures, the camera capture one picture for each preset single-capturing time interval, until the number of captured pictures reaches a preset per-group number, i.e., 21 pictures, and the preset single-capturing time interval may be 0.8 seconds;

a step 304: sending, if there is an unlighted electronic shelf label, the lighting signal to the unlighted electronic shelf label in a preset detection time;

wherein the preset detection time may be 20 minutes, and at the 20th minute, detecting whether there is unlighted electronic shelf label, and sending the lighting trigger signal to the unlighted electronic shelf label, and the unlighted electronic shelf label lights up according to its preset lighting color sequence upon receipt of the lighting trigger signal;

a step 305: the camera sends the image data to the detection module;

a step 306: the detection module inputs the image data of the electronic shelf label into an electronic shelf label identification model to obtain identifiers of all electric shelf labels;

a step 307: the detection module determines positions of the electronic shelf labels on the shelf based on the identifiers of the electric shelf labels;

wherein the positions of products corresponding to the electronic shelf labels on the shelf can be determined once the positions of the electronic shelf labels on the shelf have been determined by the detection module based on the identifiers of the electric shelf labels.

In the above embodiment, the power consumption of the electronic shelf label for lighting up is very low. The battery of the electronic shelf label can work for five years based on one hour of lighting time per day. The electronic shelf label lights up for only 2 minutes and 30 seconds or even shorter when being detected, so the detection cost is low.

In the apparatus provided by an embodiment of the present disclosure, the lighting control module sends the lighting signal to the electronic shelf label, the electronic shelf label lights up according to the preset lighting rule upon receipt of the lighting signal, the camera captures a picture of the electronic shelf label according to a preset capturing rule to obtain image data of the electronic shelf label after the electronic shelf label lights up, and the detection module determines the position of the electronic shelf label on the shelf based on the image data of the electric shelf label. The process of lighting the electronic shelf labels, taking photos to obtain the image data of the electronic shelf labels, and obtaining the positions of the electric shelf labels on the shelf are all completed automatically without manual participation, thereby improving the efficiency of position detection of electronic shelf labels.

In addition, the lighting control module sends a lighting signal within preset detection time to the electronic shelf labels that are not lighted, and the camera keeps taking photos of the electronic shelf labels according to the preset photographing rule until the photographing time reaches the preset total photographing time, so that all electronic shelf labels can be detected, thereby improving the detection success rate. The identifiers of the electronic shelf labels can be obtained only by inputting the image data of the electronic shelf labels into the electronic shelf label recognition model, which is a simple method with high efficiency and high accuracy. The identifiers of the electronic shelf labels can be obtained from the electronic shelf label recognition model only based on the lighting color of the electronic shelf labels. Since the lighting color is easy to distinguish, the accuracy of the identification of the electronic shelf labels can be up to 99.99%. In the embodiment of the disclosure, the power consumption of the electronic shelf labels for lighting up is extremely low, and the detection cost is low.

Based on the same inventive concept as the device for position detection of electronic shelf labels, an embodiment of the present disclosure further provides a method for position detection of electronic shelf labels. The method is realized based on the same principle as the device for position detection of electronic shelf labels and will not be repeated here.

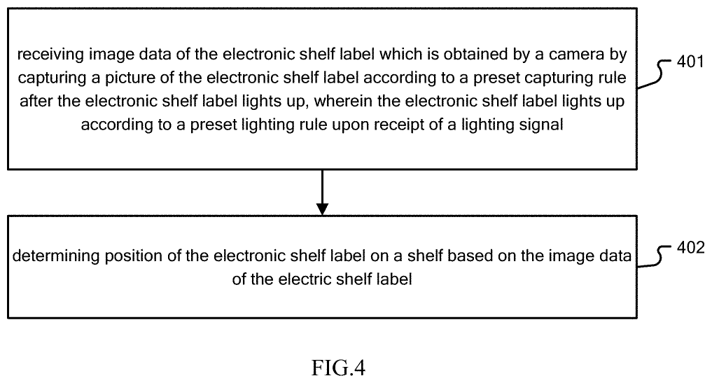

FIG. 4 is a flowchart of a method for position detection of electronic shelf labels according to an embodiment of the present disclosure. As shown in FIG. 4, the method comprises:

a step 401: receiving image data of electronic shelf labels which are obtained by a camera by taking photos of the electronic shelf labels according to a preset photographing rule when the electronic shelf labels light up according to their respective preset lighting rules after receiving a lighting signal;

a step 402: determining positions of the electronic shelf labels on the shelf based on the image data of the electric shelf labels.

In an embodiment, the method further comprises:

sending a lighting signal to the electronic shelf labels;

sending a lighting signal again within a preset detection time to the electronic shelf labels that are not lighted.

In an embodiment, determining the positions of the electronic shelf labels on the shelf based on the image data of the electric shelf labels comprises:

inputting the image data of the electronic shelf labels into an electronic shelf label recognition model to obtain identifiers of the electric shelf labels;

determining positions of the electronic shelf labels on the shelf based on the identifiers of the electric shelf labels.

In an embodiment, the electronic shelf label recognition model may be obtained by the following training process:

obtaining historical image data of the electronic shelf labels;

identifying a starting lighting color and coded lighting colors of each electronic shelf label from the historical image data;

training an electronic shelf label recognition model with the starting lighting colors and the coded lighting colors of each electronic shelf label;

adjusting parameters of the electronic shelf label recognition model in the training process until a loss function of the electronic shelf label recognition model meets a preset convergence condition to determine the trained electronic shelf label recognition model.

In the method provided by an embodiment of the present disclosure, the process of receiving the image data of the electronic shelf labels, and determining the positions of the electronic shelf labels on the shelf based on the image data of the electric shelf labels are all completed automatically without manual participation, thereby improving the efficiency of position detection of electronic shelf labels. In addition, the lighting control module sends a lighting signal within preset detection time to the electronic shelf labels that are not lighted, and the camera keeps taking photos of the electronic shelf labels according to the preset photographing rule until the photographing time reaches the preset total photographing time, so that all electronic shelf labels can be detected, thereby improving the detection success rate. The identifiers of the electronic shelf labels can be obtained only by inputting the image data of the electronic shelf labels into the electronic shelf label recognition model, which is a simple method with high efficiency and high accuracy. The identifiers of the electronic shelf labels can be obtained from the electronic shelf label recognition model only based on the lighting color of the electronic shelf labels. Since the lighting color is easy to distinguish, the accuracy of the identification of the electronic shelf labels can be up to 99.99%. In the embodiment of the disclosure, the power consumption of the electronic shelf labels for lighting up is extremely low, and the detection cost is low.

Those skilled in the art should understand that the embodiments of this disclosure can be provided as methods, systems or computer program products. Therefore, this disclosure may be implemented in the form of fully-hardware embodiments, fully-software embodiments, or combined software-hardware embodiments. In addition, this disclosure may employ the form of a computer program product implemented on one or more computer storage medium (including but not limited to disk memory, CD-ROM, and optical memory) containing computer programming code.

This disclosure is set forth by referring to flow charts and/or block diagrams for the methods, devices (systems), and computer program products of the embodiments. It should be understood that each process and/or block of the flow charts and/or block diagrams as well as combinations of the processes and/or boxes of the flow charts and/or block diagrams can be realized by computer program instructions. These computer program instructions can be provided to general-purpose computers, special-purpose computers, embedded processors or the processors of other programmable data processing devices to produce a machine, so that an apparatus for implementing the functions designated in one or more processes of the flowcharts and/or one or more blocks of the block diagrams can be produced by the instructions executed by the processor of the computer or other programmable data processing device.

These computer program instructions can also be stored in a computer-readable storage medium which can guide a computer or other programmable data processing device to operate in a particular way, so that an article of manufacture comprising an instruction apparatus can be produced by the instructions stored in the storage medium, with the instruction apparatus implementing the functions designated in one or more processes of the flowcharts and/or one or more blocks of the block diagram.

These computer program instructions may also be loaded onto a computer or other programmable data processing device to make the computer or other programmable data processing device perform a sequence of computer-implemented operations, so that the instructions executed by the computer or other programmable data processing device realize one or more processes of the flowcharts and/or one or more blocks of the block diagram.

The purpose, technical features and technical effects of the present disclosure have been further described above by means of some embodiments. It should be understood that the embodiments are meant to facilitate understanding of the principles of the present disclosure, and those skilled in the art can make any modifications based on the teachings of this disclosure. This specification shall not be construed as any limitation to the present disclosure.

1. An apparatus for detecting position of an electronic shelf label, comprising:
a lighting control module configured to send a lighting signal to the electronic shelf label;
the electronic shelf label, which is configured to light up according to a preset lighting rule upon receipt of the lighting signal;
a camera configured to capture a picture of the electronic shelf label according to a preset capturing rule to obtain image data of the electronic shelf label, after the electronic shelf label lights up;
a detection module configured to determine position of the electronic shelf label on a shelf based on the image data of the electric shelf label.

2. The apparatus according to claim 1, wherein the lighting control module is further configured to send, if there is an unlighted electronic shelf label, the lighting signal to the unlighted electronic shelf label in a preset detection time.

3. The apparatus according to claim 1, wherein the lighting signal is a lighting trigger signal;
the electronic shelf label is configured to, upon receipt of the lighting trigger signal, light up cyclically according to a preset lighting color sequence until a summed-up lighting time reaches a preset total lighting time, with the time of each lighting being a preset single lighting time;
wherein the preset lighting color sequence comprises a starting lighting color and at least two coded lighting colors different from the starting lighting color, and adjacent coded lighting colors of the preset lighting color sequence are different from each other.

4. The apparatus according to claim 1, wherein the detection module is configured to:
input the image data of the electronic shelf label into an electronic shelf label identification model to obtain an identifier of the electric shelf label;
determine the position of the electronic shelf label on the shelf based on the identifier of the electric shelf label.

5. The apparatus according to claim 4, wherein the electronic shelf label identification model is obtained by a training which includes:
obtaining historical image data of the electronic shelf label;
identifying a starting lighting color and coded lighting colors of the electronic shelf label from the historical image data;
training the electronic shelf label identification model with starting lighting color and coded lighting colors of the electronic shelf label;
adjusting parameters of the electronic shelf label identification model in the training, until a loss function of the electronic shelf label identification model meets a preset convergence condition, thereby obtaining a trained electronic shelf label identification model.

6. The apparatus according to claim 3, wherein the camera is configured to capture a group of pictures for each preset group-capturing time interval, until a summed-up capturing time reaches a preset total capturing time.

7. The apparatus according to claim 6, wherein the camera is configured to capture one picture for each preset single-capturing time interval, until the number of captured pictures reaches a preset per-group number, wherein the preset single-capturing time interval is shorter than the preset single lighting time.

8. A method for detecting position of an electronic shelf label, comprising:
receiving image data of the electronic shelf label which is obtained by a camera by capturing a picture of the electronic shelf label according to a preset capturing rule after the electronic shelf label lights up, wherein the electronic shelf label lights up according to a preset lighting rule upon receipt of a lighting signal;
determining position of the electronic shelf label on a shelf based on the image data of the electric shelf label.

9. The method according to claim 8, further comprising:
sending a lighting signal to the electronic shelf labels;
sending, if there is an unlighted electronic shelf label, the lighting signal to the unlighted electronic shelf label in a preset detection period.

10. The method for position detection of electronic shelf labels according to claim 8, wherein determining position of the electronic shelf label on the shelf based on the image data of the electric shelf label comprises:
inputting the image data of the electronic shelf label into an electronic shelf label identification model to obtain an identifier of the electric shelf label;
determining the position of the electronic shelf label on the shelf based on the identifier of the electric shelf label.

11. The method for position detection of electronic shelf labels according to claim 8, wherein the electronic shelf label identification model is obtained by a training which includes:
obtaining historical image data of the electronic shelf label;
identifying a starting lighting color and coded lighting colors of the electronic shelf label from the historical image data;
training the electronic shelf label identification model with starting lighting color and coded lighting colors of the electronic shelf label;
adjusting parameters of the electronic shelf label identification model in the training, until a loss function of the electronic shelf label identification model meets a preset convergence condition, thereby obtaining a trained electronic shelf label identification model.

12. A computer device comprising a memory, a processor and a computer program stored in the memory and executable on the processor, wherein the processor executes the computer program to implement the method according to claim 8.

13. (canceled)
